(19) United States
(12) Patent Application Publication
(10) Pub. No.: US 2010/0294439 A1
(43) Pub. Date: Nov. 25, 2010

(54) Cellular Shade

(75) Inventor: Che-Min SU, Changhua County (TW)

Correspondence Address: Che-Min SU, P.O. Box 44-295, Taipei, Taiwan, Taipei, 10699, omitted

(73) Assignee: Ching Feng Home Fashion Co., Ltd., Changhua County (TW)

(21) Appl. No.: 12/469,684

(22) Filed: May 21, 2009

(51) Int. Cl. E06B 9/24

(52) U.S. Cl. 160/84.05

(57) ABSTRACT

A cellular shade includes stacked and interconnected strips. Each of the strips includes a first half and a second half extended from the first half. The second half of each of the strips is made as a pleat with a first connective portion extended from the first half of the strip at an angle and a second connective portion extended from the first connective portion of the strip. The second connective portion of each of the strips is connected to the first half of an adjacent one of the strips so that the cellular shade exhibits a smoothly curved profile.

### FIELD OF THE INVENTION

The present invention relates to a shade and, more particularly, to a cellular shade.

### RELATED PRIOR ART

Blinds, curtains and shades are used near doors and windows for shading and/or decoration. There are various shades such as Venetian blinds, curtains, Roman curtains and cellular shades. A blind, curtain or shade is generally collapsible.

For aesthetic reasons, a cellular shade includes strips in a first color and other strips in a second color for aesthetic purposes. The strips in the first color are alternatively arranged with the strips in the second color. The strips are attached to one another in certain positions. The strips are provided between upper and lower beams. Two cords are used to pull the lower beam towards the upper beam, i.e., to collapse the cellular shade. When the upper beam is moved from the upper beam, the strips together form a cellular structure, i.e., the cellular shade is extended.

Various conventional cellular shades are addressed as PRIOR ART in U.S. Pat. No. 5,193,601. Each of these conventional cellular shades includes strips that are made separately and then connected to one another to form a cellular structure. These conventional cellular shades are not aesthetically pleasing for including sharp corners and planar faces.

Another conventional cellular shade is described as the invention in U.S. Pat. No. 5,193,601. This conventional cellular shade is made of a single long strip. The strip is folded into a plurality of pleats, and the pleats are connected to one another. This conventional cellular shade is not aesthetically pleasing for including sharp corners and planar faces.

Referring to FIG. 10, another conventional cellular shade is made of a single long strip. The strip is folded into a plurality of pleats, and the pleats are connected to one another. This conventional cellular shade is not aesthetically pleasing for including sharp corners, planar faces and plain cells in the form of a rhombus.

As described in U.S. Pat. No. 6,527,895, another conventional cellular shade includes a plurality of strips each including a fold 12 and two ends 14. The strips are arranged in a same direction. Each of the ends 14 of each of the strips is connected to a related one of the ends 14 of an adjacent one of the strips with a glue bead 20. This conventional cellular shade is not aesthetically pleasing because the ends 14 are located on a same side and the glue beads 20 are visible.

The present invention is therefore intended to obviate or at least alleviate the problems encountered in prior art.

### SUMMARY OF THE INVENTION

It is the primary objective of the present invention to provide an aesthetically pleasing cellular shade.

To achieve the foregoing objective, the cellular shade includes stacked and interconnected strips. Each of the strips includes a first half and a second half extended from the first half. The second half of each of the strips is made as a pleat with a first connective portion extended from the first half of the strip at an angle and a second connective portion extended from the first connective portion of the strip. The second connective portion of each of the strips is connected to the first half of an adjacent one of the strips. Thus, the cellular shade exhibits a smoothly curved profile.

Other objectives, advantages and features of the present invention will become apparent from the following description referring to the attached drawings.

### BRIEF DESCRIPTION OF THE DRAWINGS

The present invention will be described via detailed illustration of two embodiments referring to the drawings.

FIG. 1 shows a process for folding a strip for use in a cellular shade according to the first embodiment of the present invention.

FIG. 2 is a perspective view of the strip after the folding process shown in FIG. 1.

FIG. 3 is another perspective view of the strip shown in FIG. 2.

FIG. 4 is a partial, perspective view of the strip shown in FIG. 2.

FIG. 5 is a partial view of a cellular shade made of strips as shown in FIG. 2 and strips as shown in FIG. 3.

FIG. 6 is a side view of the cellular shade shown in FIG. 5.

FIG. 7 is a perspective view of the cellular shade shown in FIG. 5.

FIG. 8 is a partial, exploded, side view of a cellular shade according to the second embodiment of the present invention.

FIG. 9 is a partial, side view of the cellular shade shown in FIG. 8.

FIG. 10 is a partial, side view of a conventional cellular shade.

### DETAILED DESCRIPTION OF THE EMBODIMENTS

Referring to FIG. 7, a cellular shade 1 includes strips located between two beams 22 and 23. Preferably, the strips are made as portions of a longer strip. However, the strips can be made separately and connected to one another in another embodiment.

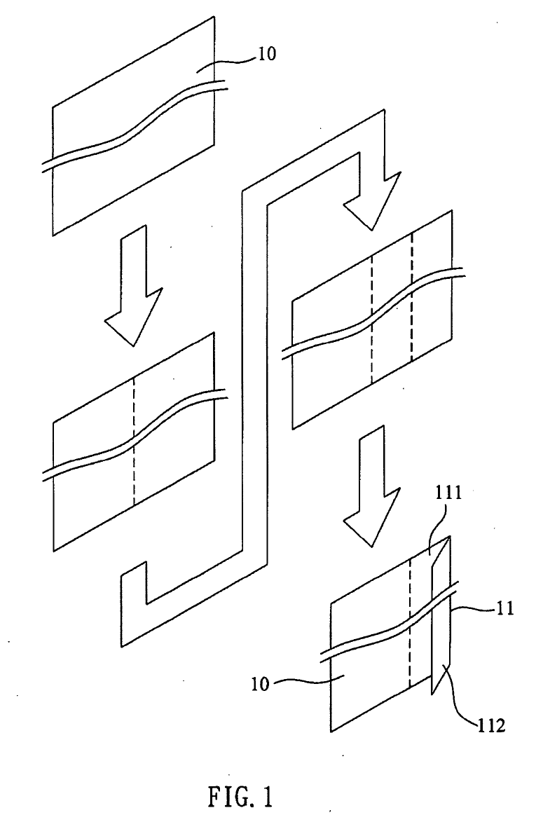

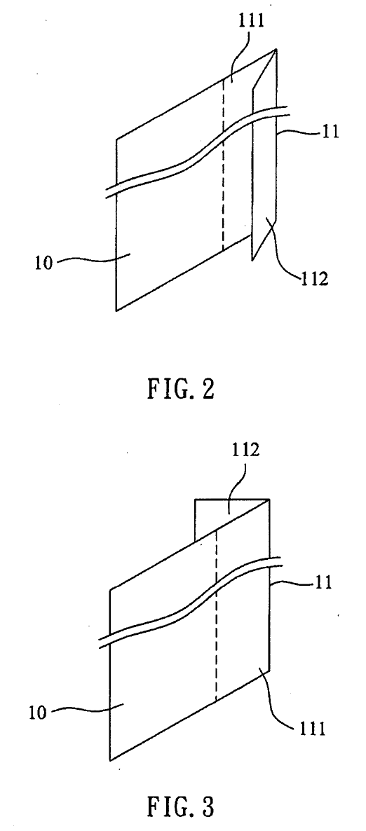

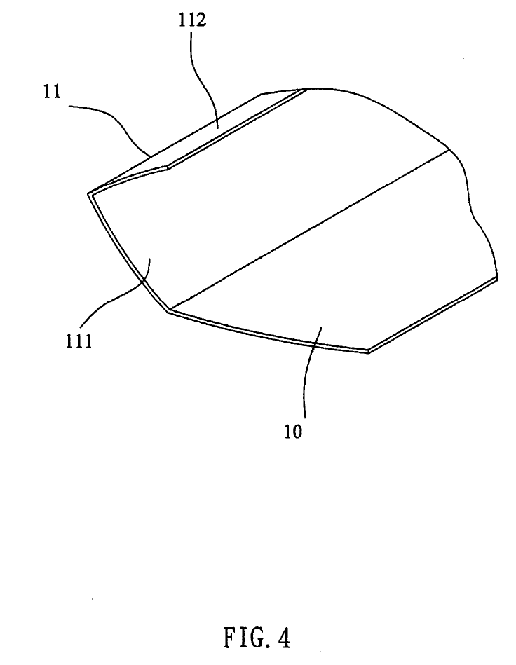

Referring to FIGS. 1 through 4, there is shown a strip 10 for use in the cellular shade 1. The strip 10 is folded in half, thus dividing the strip into two halves. The first half of the strip 10 is retained substantially planar. The second half of the strip 10 is folded, thus forming a pleat 11 with a first connective portion 111 located at an angle from the first half of the strip 10 and a second connective portion 112 located at an angle from the first connective portion 111.

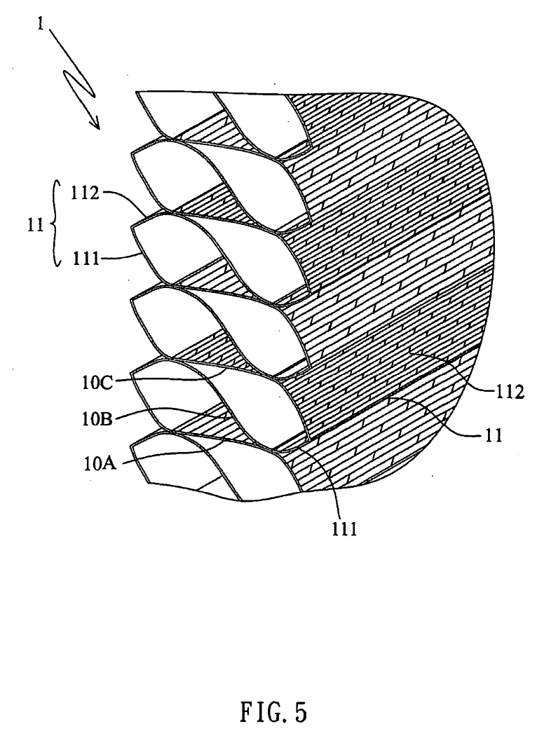

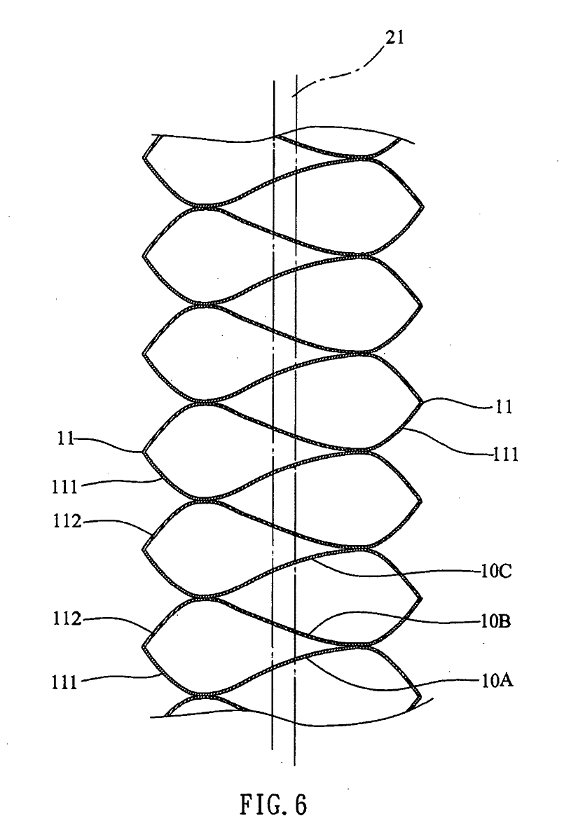

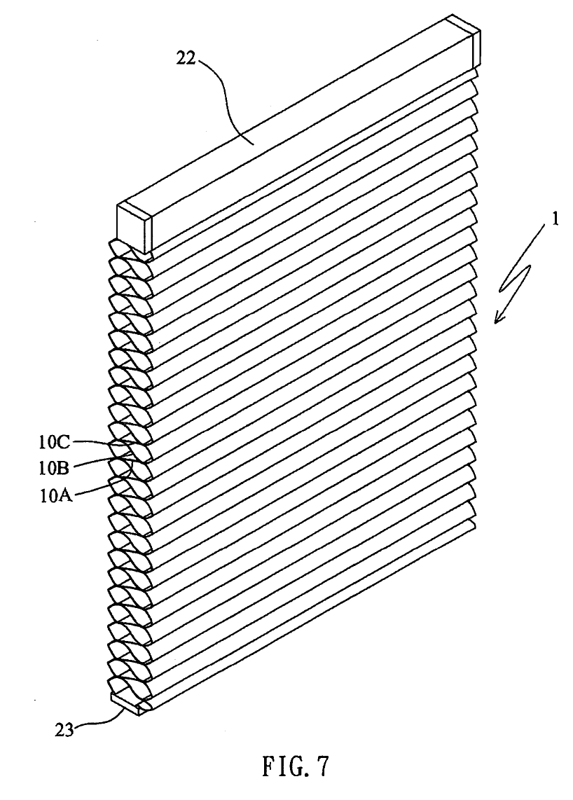

Referring to FIGS. 5 and 6, the cellular shade 1 is shown. Three strips 10A, 10B and 10C will be described for example. The strips 10A, 10B and 10C are identical to the strip 10 described referring to FIGS. 1 through 4. The strips 10A and 10B are arranged in different directions so that the pleat 11 of the strip 10A is located on a side while the pleat 11 of the strip 10B is located on an opposite side. The second connective portion 112 of the strip 10A is connected to the first half of the strip 10B. The strips 10B and 10C are arranged in different directions so that the pleat 11 of the strip 10B is located on a side while the pleat 11 of the strip 10C is located on an opposite side. The second connective portion 112 of the strip 10B is connected to the first half of the strip 10C. This process is repeated so that the cellular shade 1 is made with a desired dimension referring to FIG. 7.

The cellular shade 1 can be extended for shading and decoration. There are strips such as the strips 10A and 10C in a first color and other strips such as the strip 10B in a second color for aesthetic purposes. The strips exhibit a soft profile.

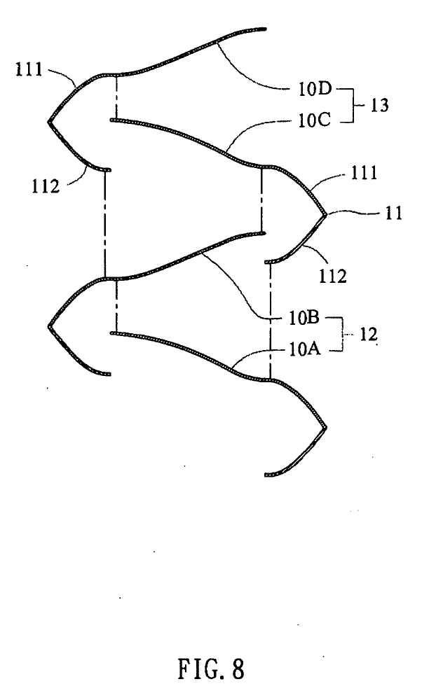

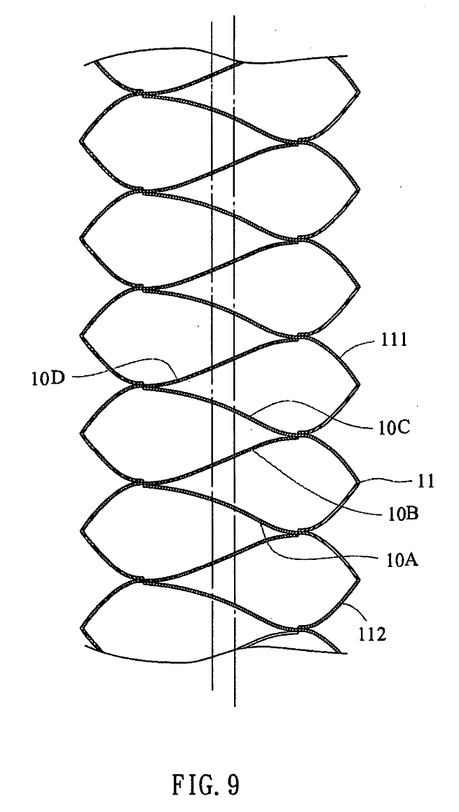

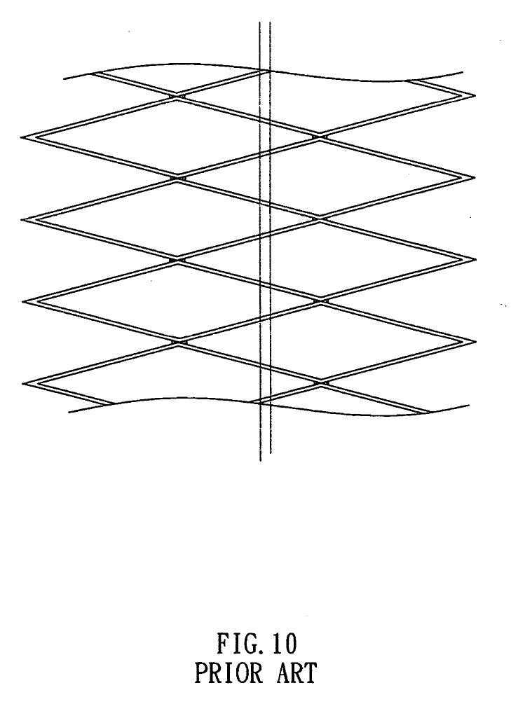

Referring to FIGS. 8 and 9, there is shown a cellular shade according to a second embodiment of the present invention. The second embodiment is like the first embodiment except that the strips are made separately and then connected to one another in any proper manner such as gluing. The strip 10A includes an external side and an internal side. Referring to FIGS. 5 and 6, the cellular shade 1 is shown. The internal side of the second connective portion 112 of the strip 10B is connected to the internal side of the first half of the strip 10A. The internal side of the second connective portion 112 of the strip 10C is connected to the internal side of the first half of the strip 10B. The internal side of the second connective portion 112 of a strip 10D is connected to the internal side of the first half of the strip 10C. This process is repeated so that the cellular shade 1 is made with a desired dimension.

In another embodiment, the external side of the first half of the strip 10A is connected to the external side of the second connective portion 112 of the strip 10B. The external side of the first half of the strip 10B is connected to the external side of the second connective portion 112 of the strip 10C. The external side of the first half of the strip 10C is connected to the external side of the second connective portion 112 of the strip 10D. This process is repeated so that the cellular shade 1 is made with a desired dimension.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A cellular shade comprising stacked and interconnected strips each comprising:
a first half; and
a second half extended from the first half and made as a pleat comprising:
a first connective portion extended from the first half of the strip at an angle; and
a second connective portion extended from the first connective portion of the strip, wherein the second connective portion of the strip is connected to the first half of an adjacent strip so that the cellular shade exhibits a smoothly curved profile.

2. The cellular shade according to claim 1, wherein some of the strips are in a first color while the other strips are in a second color, and the strips in the first color are alternatively arranged with the strips in the second color.

3. The cellular shade according to claim wherein 1, an external side of the second connective portion of each of the strips is connected to an external side of the first half of an adjacent one of the strips.

4. The cellular shade according to claim wherein 1, an internal side of the second connective portion of each of the strips is connected to an internal side of the first half of an adjacent one of the strips.
